(19) United States
(12) Patent Application Publication
(10) Pub. No.: US 2025/0297874 A1
(43) Pub. Date: Sep. 25, 2025

(54) QUANTIFICATION OF LIQUID AND CORRECTION OF GAS FLOW RATE IN A GAS PIPELINE USING PHASE BEHAVIOR

(71) Applicant: Chevron U.S.A. Inc., San Ramon, CA (US)

(72) Inventors: Pamela I. Chacon, Magnolia, TX (US); Lisa A. Brenskelle, Houston, TX (US)

(21) Appl. No.: 18/869,743

(22) PCT Filed: Jun. 2, 2023
(86) PCT No.: PCT/US23/24313

§ 371 Date: Nov. 26, 2024

Related U.S. Application Data
(60) Provisional application No. 63/348,832, filed on Jun. 3, 2022.

(51) Int. Cl. G01F 1/42

(52) U.S. Cl. CPC G01F 1/42

(57) ABSTRACT

Fluid composition inside a pipe and operating condition (e.g., temperature, pressure) inside the pipe are used to determine liquid quantity in the pipe. The liquid quantity in the pipe is used to determine whether liquid is present in the pipe. If liquid is present in the pipe, over/under reading of gas flow in the pipe may occur, and the over/under reading of gas flow in the pipe is used to correct gas flow rate measurement in the pipe. Liquid flow rate may also be determined.

### CROSS-REFERENCE TO RELATED APPLICATIONS

The present application claims the benefit of U.S. Provisional Application No. 63/348,832, entitled “QUANTIFICATION OF LIQUID AND CORRECTION OF GAS FLOW RATE IN A GAS PIPELINE USING PHASE BEHAVIOR” which was filed on Jun. 3, 2022, the entirety of which is hereby incorporated herein by reference.

### FIELD

The present disclosure relates generally to the field of quantifying liquid and correcting gas flow rate in a gas pipeline.

### BACKGROUND

Liquid in a gas pipeline may impact the accuracy of gas flow measurement. The presence of liquid in gas may cause over/under reading of gas flow in the pipeline. Determination of liquid quantity in the pipe may have significant impact on revenue.

### SUMMARY

This disclosure relates to quantifying liquid and correcting gas flow rate in a gas pipeline. Fluid composition information, pipe operation information, and/or other information may be obtained. The fluid composition information may define fluid composition in a pipe. The pipe operation information may define operating characteristics in the pipe. Liquid quantity in the pipe may be determined based on the fluid composition in the pipe, the operating characteristics in the pipe, and/or other information. Whether liquid is present in the pipe may be determined based on the liquid quantity in the pipe and/or other information. Responsive to the determination that liquid is present in the pipe, a liquid-corrected gas flow rate in the pipe may be determined based on the fluid composition in the pipe, the operating characteristics in the pipe, the liquid quantity in the pipe, and/or other information.

A system for quantifying liquid and correcting gas flow rate in a gas pipeline may include one or more electronic storage, one or more processors and/or other components. The electronic storage may store fluid composition information, information relating to fluid composition in a pipe, pipe operation information, information relating to operating characteristics in the pipe, information relating to uncorrected gas flow rate in the pipe, information relating to liquid presence in the pipe, information relating to liquid quantity in the pipe, information relating to liquid-corrected gas flow rate in the pipe, and/or other information.

The processor(s) may be configured by machine-readable instructions. Executing the machine-readable instructions may cause the processor(s) to facilitate quantifying liquid in gas pipeline. The machine-readable instructions may include one or more computer program components. The computer program components may include one or more of a fluid composition component, a pipe operation component, a liquid quantity component, a liquid presence component, a correction component, and/or other computer program components.

The fluid composition component may be configured to obtain fluid composition information and/or other information. The fluid composition information may define fluid composition in a pipe. In some implementations, the fluid composition in the pipe may include a breakdown of fluid components in the pipe by number and/or mass.

The pipe operation component may be configured to obtain pipe operation information and/or other information. The pipe operation information may define operating characteristics in the pipe. In some implementations, the operating characteristics in the pipe include temperature, differential pressure, static pressure, uncorrected gas flow rate in the pipe, and/or other operating characteristics.

In some implementations, a flow restriction may be located along the pipe. The differential pressure may be measured between a first point along the pipe and a second point along the pipe. The first point may be on a first side of the flow restriction and the second point may be on a second side of the flow restriction. The static pressure may be measured on the first side or the second side of the flow restriction.

The liquid quantity component may be configured to determine liquid quantity in the pipe. The liquid quantity in the pipe may be determined based on the fluid composition in the pipe, the operating characteristics in the pipe, and/or other information. In some implementations, the determination of the liquid quantity in the pipe based on the fluid composition in the pipe and the operating characteristics in the pipe may include determination of phase in the pipe based on the breakdown of the fluid components in the pipe by number and/or mass, the temperature, and the static pressure.

In some implementations, the determination of the liquid quantity in the pipe may include determination of a liquid fraction in the pipe. In some implementations, the determination of the liquid quantity in the pipe may further include determination of a liquid flow rate in the pipe. In some implementations, total transferred liquid over a time period may be determined based on the liquid flow rate and/or other information.

The liquid presence component may be configured to determine whether liquid is present in a pipe. Whether liquid is present in the pipe may be determined based on the liquid quantity in the pipe and/or other information.

The correction component may be configured to, responsive to the determination that liquid is present in the pipe, determine a liquid-corrected gas flow rate in the pipe. The liquid-corrected gas flow rate in the pipe may be determined based on the fluid composition in the pipe, the operating characteristics in the pipe, the liquid quantity in the pipe, and/or other information.

In some implementations, the determination of the liquid-corrected gas flow rate in the pipe based on the fluid composition in the pipe, the operating characteristics in the pipe, and the liquid quantity in the pipe may include: determination of an uncorrected gas flow rate in the pipe based on the fluid composition in the pipe and the operating characteristics in the pipe or based on gas flow rate measurement; determination of an over-read or an under-read of the uncorrected gas flow rate in the pipe based on the liquid quantity in the pipe; and determination of the liquid-corrected gas flow rate in the pipe based on the uncorrected gas flow rate in the pipe and the over-read or the under-read of the gas flow rate in the pipe.

In some implementations, total transferred gas over a time period is determined based on the liquid-corrected gas flow rate and/or other information.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for quantifying liquid and correcting gas flow rate in gas pipeline.

FIG. 2 illustrates an example method for quantifying liquid and correcting gas flow rate in gas pipeline.

FIG. 3 illustrates an example pipe.

FIG. 4 illustrates an example phase diagram.

FIG. 5 illustrates an example flow diagram for correcting gas flow rate in a pipe.

### DETAILED DESCRIPTION

The present disclosure relates to quantifying liquid and correcting gas flow rate in a gas pipeline. Fluid composition inside a pipe and operating condition (e.g., temperature, pressure) inside the pipe are used to determine liquid quantity in the pipe. The liquid quantity in the pipe is used to determine whether liquid is present in the pipe. If liquid is present in the pipe, over/under reading of gas flow in the pipe is determined, and the over/under reading of gas flow in the pipe is used to correct gas flow rate measurement in the pipe.

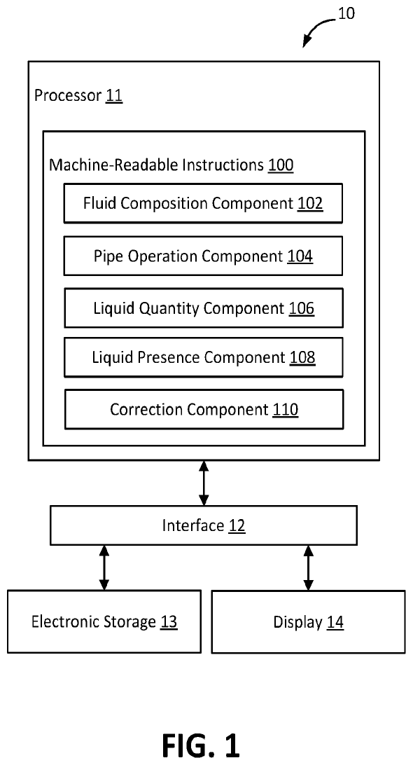

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a display 14, and/or other components. Fluid composition information, pipe operation information, and/or other information may be obtained by the processor 11. The fluid composition information may define fluid composition in a pipe. The pipe operation information may define operating characteristics in the pipe. Liquid quantity in the pipe may be determined by the processor 11 based on the fluid composition in the pipe, the operating characteristics in the pipe, and/or other information. Whether liquid is present in the pipe may be determined by the processor 11 based on the liquid quantity in the pipe and/or other information. Responsive to the determination that liquid is present in the pipe, a liquid-corrected gas flow rate in the pipe may be determined by the processor 11 based on the fluid composition in the pipe, the operating characteristics in the pipe, the liquid quantity in the pipe, and/or other information.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store fluid composition information, information relating to fluid composition in a pipe, pipe operation information, information relating to operating characteristics in the pipe, information relating to uncorrected gas flow rate in the pipe, information relating to liquid presence in the pipe, information relating to liquid quantity in the pipe, information relating to liquid-corrected gas flow rate in the pipe, and/or other information.

The display 14 may refer to an electronic device that provides visual presentation of information. The display 14 may include a color display and/or a non-color display. The display 14 may be configured to visually present information. The display 14 may present information using/within one or more graphical user interfaces. For example, the display 14 may present information relating to a pipe, information relating to fluid composition in the pipe, information relating to operating characteristics in the pipe, information relating to uncorrected gas flow rate in the pipe, information relating to liquid presence in the pipe, information relating to liquid quantity in the pipe, information relating to liquid-corrected gas flow rate in the pipe, information relating to liquid flow rate in the pipe, and/or other information.

Accurately measuring flow of gas and liquid in a gas pipeline may be critical for many applications, such as reservoir and well management, production optimization, flow assurance issues, production allocation, and custody transfer. The presence of liquid in a pipe may reduce the accuracy of gas flow measurement in the pipe. For example, presence of liquid in a pipe may result in overread/underread of gas flow measurement in the pipe. The presence of liquid in a pipe may result in the measured (uncorrected) gas flow rate being higher/lower than the actual gas flow rate in the pipe. Quantifying the liquid in the pipe may enable more accurate measurement of gas flow in the pipe and allow for liquid transfer through the pipe to be measured. However, existing wet gas (gas that includes/carries liquid) meters leverage multiple measurement components and are costly to install and maintain.

The current disclosure provides for correction of gas flow measurement using phase behavior. The properties and characteristics of the fluid flowing through the pipe, including fluid composition, temperature, differential pressure, and static pressure, are analyzed using a phase behavior model, such as an equation of state model, to determine liquid fraction in the pipe. The liquid fraction in the pipe is used to correct the gas flow measured in the pipe and to quantify the liquid flow rate in the pipe. The current disclosure provides a simple and low-cost technique to detect the presence of liquid in a pipe and quantify the effect of the liquid in the pipe on gas flow measurement.

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate quantifying liquid and correcting gas flow rate in gas pipeline. The machine-readable instructions 100 may include one or more computer program components. The machine-readable instructions 100 may include a fluid composition component 102, a pipe operation component 104, a liquid quantity component 106, a liquid presence component 108, a correction component 110, and/or other computer program components.

The fluid composition component 102 may be configured to obtain fluid composition information and/or other information. Obtaining fluid composition information may include one or more of accessing, acquiring, analyzing, determining, examining, generating, identifying, loading, locating, measuring, opening, receiving, retrieving, reviewing, selecting, storing, and/or otherwise obtaining the fluid composition information. The fluid composition component 102 may obtain fluid composition information from one or more locations. For example, the fluid composition component 102 may obtain fluid composition information from a storage location, such as the electronic storage 13, electronic storage of a device accessible via a network, and/or other locations. The fluid composition component 102 may obtain fluid composition information from one or more hardware components (e.g., a computing device, a gas sensor, a fluid composition sensor, a gas chromatography machine) and/or one or more software components (e.g., software running on a computing device). For example, the fluid composition component 102 may obtain fluid composition information by using one or more gas sensors/fluid composition sensors/gas chromatography machines to determine/measure composition of fluid (gas, liquid) flowing through the pipe.

The fluid composition information may define fluid composition in a pipe. Fluid composition in the pipe may refer to the makeup, constituents, elements, and/or substances of fluid in the pipe. Fluid may exist in one or more forms within the pipe, such as liquid and/or gas. Fluid in the pipe may be made up of one or more fluid components (one or more types of liquid, one or more types of gas). Fluid composition in the pipe may refer to identity and/or amount of fluid components in the pipe. For example, the fluid composition in the pipe defined by the fluid composition information may include a breakdown of gas components and/or liquid components in the pipe by number (e.g., mole fraction) and/or mass (e.g., mass fraction). As another example, the fluid composition in the pipe defined by the fluid composition information may include a breakdown of gas components and/or liquid components in the pipe by volume.

The fluid composition information may define fluid composition in a pipe by including information that characterizes, describes, delineates, identifies, is associated with, quantifies, reflects, sets forth, and/or otherwise defines one or more of value, property, quality, quantity, attribute, feature, and/or other aspects of the fluid composition in the pipe. The fluid composition information may directly and/or indirectly define fluid composition in a pipe. For example, the fluid composition information may define fluid composition in a pipe by including information that specifies the identity and/or amount of fluid components in a pipe and/or information that may be used to determine the identity and/or amount of fluid components in a pipe. Other types of fluid composition information are contemplated.

The fluid composition information obtained by the fluid composition component 102 may include historical fluid composition information and/or real-time fluid composition information. Historical fluid composition information may refer to fluid composition information that defines past fluid composition in the pipe. For example, historical fluid composition information may define the fluid composition in the pipe at a point in time or over a period of time in the past that extends beyond a threshold amount of time (e.g., fluid composition measured over the last month, fluid composition measured one month ago). Real-time fluid composition information may refer to fluid composition information that defines current fluid composition in the pipe. For example, real-time fluid composition information may define the fluid composition in the pipe currently being measured by a gas sensor/fluid composition sensor/gas chromatography machine or that has been measured within a threshold amount of time (e.g., fluid composition measured within the past day/hour/minute). Real-time fluid composition in the pipe may be measured at a point in time or over a period of time.

In some implementations, obtaining the fluid composition information may include estimating the fluid composition in the pipe using historical fluid composition information, real-time fluid composition information, and/or other information. For example, historical fluid composition information may define fluid composition in the pipe at multiple moments in the past and provide historical data of fluid composition over time. The historical data of the fluid composition over time may be used to estimate the current fluid composition in the pipe. For example, linear interpolation may be performed on the historical data of fluid composition over time to estimate the current fluid composition in the pipe. Other estimation of fluid composition in the pipe using historical and/or real-time fluid composition information is contemplated.

The pipe operation component 104 may be configured to obtain pipe operation information and/or other information. Obtaining pipe operation information may include one or more of accessing, acquiring, analyzing, determining, examining, generating, identifying, loading, locating, measuring, opening, receiving, retrieving, reviewing, selecting, storing, and/or otherwise obtaining the pipe operation information. The pipe operation component 104 may obtain pipe operation information from one or more locations. For example, the pipe operation component 104 may obtain pipe operation information from a storage location, such as the electronic storage 13, electronic storage of a device accessible via a network, and/or other locations. The pipe operation component 104 may obtain pipe operation information from one or more hardware components (e.g., a computing device, a pressure sensor, a differential pressure sensor, a temperature sensor) and/or one or more software components (e.g., software running on a computing device). For example, the pipe operation component 104 may obtain pipe operation information by using one or more pressure sensors, one or more differential pressure sensors, and/or one or more temperature sensors to determine/measure operating characteristics in a pipe. The pipe operation component 104 may obtain pipe operation information by using one or more flow meters to determine/measure uncorrected gas flow rate in the pipe. Use of other sensors is contemplated.

The pipe operation information may define operating characteristics in the pipe. Operating characteristics in the pipe may refer to characteristics in the pipe during an operation that utilizes the pipe in transporting materials (e.g., gas, liquid). Operating characteristics in the pipe may refer to attribute, quality, configuration, parameter, and/or characteristics of matter inside, within, and/or around the pipe during an operation that utilizes the pipe in transporting materials. For example, the operating characteristics in the pipe defined by the pipe operation information may include temperature, differential pressure, static pressure, and/or other operating characteristics in the pipe. The operating characteristics in the pipe defined by the pipe operation information may include uncorrected gas flow rate in the pipe. The temperature in the pipe may refer to the degree or intensity of heat present in the pipe/in the materials inside the pipe. The differential pressure may refer to may refer to the difference in pressure between two points along the pipe. The static pressure may refer to pressure at a point along the pipe. Uncorrected gas flow rate may refer to gas flow rate measured in the pipe. Uncorrected gas flow rate may refer to gas flow rate measured in the pipe without considering whether liquid is present in the pipe. Uncorrected gas flow rate may refer to measured gas flow rate that has not been adjusted/changed to account for presence of liquid in the pipe. Uncorrected gas flow rate may be higher or lower than the actual gas flow rate in the pipe due to the presence of liquid in the pipe.

The pipe operation information may define operating characteristics in a pipe by including information that characterizes, describes, delineates, identifies, is associated with, quantifies, reflects, sets forth, and/or otherwise defines one or more of value, property, quality, quantity, attribute, feature, and/or other aspects of the operating characteristics in the pipe. The pipe operation information may directly and/or indirectly define operating characteristics in a pipe. For example, the pipe operation information may define operating characteristics in a pipe by including information that specifies the type and/value of operating characteristics in a pipe and/or information that may be used to determine the type and/or value of operating characteristics in a pipe. Other types of pipe operation information are contemplated.

The pipe operation information obtained by the pipe operation component 104 may include historical pipe operation information and/or real-time pipe operation information. Historical pipe operation information may refer to pipe operation information that defines past operating characteristics in the pipe. For example, historical pipe operation information may define the past operating characteristics in the pipe at a point in time or over a period of time in the past that extends beyond a threshold amount of time (e.g., operating characteristics measured over the last month, operating characteristics measured one month ago). Real-time pipe operation information may refer to pipe operation information that defines current operating characteristics in the pipe. For example, real-time pipe operation information may define the operating characteristics in the pipe currently being measured by a pressure sensor/differential pressure sensor/temperature sensor or that has been measured within a threshold amount of time (e.g., operating characteristics measured within the past day/hour/minute). Real-time operating characteristics in the pipe may be measured at a point in time or over a period of time.

In some implementations, a flow restriction may be located along the pipe. A flow restriction may refer to one or more devices and/or one or more configurations of a pipe that restricts the flow of fluid through the pipe. A flow restriction may change the cross-sectional area of the pipe through which fluid flows. A flow restriction may be part of the pipe. A flow restriction may be installed in the pipe. A flow restriction may be a single phase differential pressure-based flow measurement device. For example, a flow restriction on a pipe may include an orifice plate, a Venturi, a cone, or a wedge meter. Other types of flow restriction are contemplated.

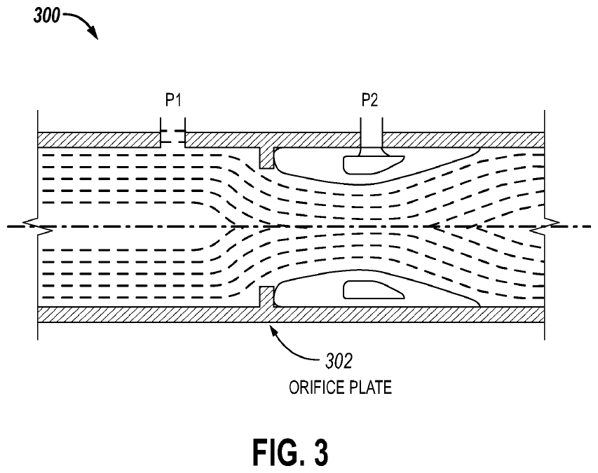

FIG. 3 illustrates an example pipe 300. The flow restriction on the pipe 300 may include an orifice plate 302. The orifice plate 302 may be located along the pipe 300. The orifice plate 302 may include a thin plate with a hole. The pipe 300 may include holes (taps) to measure pressure at different points along the pipe. For example, the pipe 300 may include holes on both sides of the orifice plate 302. The static pressure (P1 or P2) may be measured on either side of the orifice plate 302. The differential pressure (P2−P1) may be measured between the two points on different sides of the orifice plate 302. Other configurations of pipe and use of other flow restrictions are contemplated. Use of other flow meters with/without flow restrictions is contemplated.

In reference to FIG. 1, the liquid quantity component 106 may be configured to determine liquid quantity in the pipe. Determining the liquid quantity in the pipe may include ascertaining, approximating, calculating, establishing, estimating, finding, identifying, obtaining, quantifying, selecting, setting, and/or otherwise determining the liquid quantity in the pipe. The liquid quantity in the pipe may refer to the amount of liquid in the pipe. The liquid quantity in the pipe may refer to absolute and/or relative measurement of the liquid in the pipe. The liquid quantity in the pipe may refer to how much liquid (e.g., by mole fraction, by mass, by volume) is in the pipe. The liquid quantity may refer to how much liquid is in the pipe in comparison to other forms of matter, such as gas. For example, the liquid quantity in the pipe may refer to liquid fraction (e.g., liquid volume fraction, liquid mass fraction) in the pipe.

The liquid quantity component 106 may determine the liquid quantity in the pipe based on the fluid composition in the pipe, the operating characteristics in the pipe, and/or other information. The fluid composition in the pipe and the operating characteristics in the pipe may be used to estimate the liquid quantity (e.g., liquid fraction) in the pipe. In some implementations, the liquid quantity in the pipe may be determined based on phase of fluid in the pipe and/or other information. For example, the liquid fraction in the pipe may be determined based on phase of fluid in the pipe and/or other information. Phase of fluid in the pipe may refer to state of fluid in the pipe in solid, liquid, gas, and/or other form.

Determination of the liquid quantity in the pipe based on the fluid composition in the pipe and the operating characteristics in the pipe may include determination of phase of fluid in the pipe based on the breakdown of the fluid components in the pipe by number and/or mass, the temperature in the pipe, the static pressure measured at a point along the pipe, and/or other information. Determining phase in the pipe may refer to determining in which phase the fluid in the pipe is existing, such as determining that fluid exists as liquid and/or gas in the pipe. Determining phase in the pipe may refer to determining whether fluid in the pipe is existing in a single phase (e.g., as gas only) or in multiple phases (e.g., as gas and liquid).

In some implementations, the phase in the pipe may be determined using one or more phase behavior models. A phase behavior model may refer to a computer model (e.g., program, tool, script, function, process, algorithm) that simulates phase behavior of matter, such as phase behavior of fluids. In some implementations, a phase behavior model may use and/or incorporate one or more equations of state to simulate phase behavior of matter. An equation of state may refer to a thermodynamic equation relating state variables which describe the state of matter under a given set of physical conditions, such as pressure, volume, temperature (PVT), and/or internal energy. Equations of state may be used to describe the properties of fluid and mixtures of fluid, such as fluid inside a pipe. Equations of state may provide the state of fluid molecules by density, by mixing component, by energy, and/or other factors. For example, a phase behavior model or equation of state may use and/or incorporate the Gibbs free energy equations to simulate phase behavior of fluid in the pipe. For example, the Gibbs free energy minimization method may be used to calculate the gas and/or the liquid densities in the pipe. Gibbs free energy minimization may assume steady-state condition inside the pipe. Use of other phase behavior model or equation of state approaches is contemplated.

A phase behavior model may use the fluid composition in the pipe and the operating characteristics in the pipe to determine in which phase the fluid flowing through the pipe exists. For example, the phase behavior model may use the fluid composition in the pipe and the operating characteristics in the pipe to determine whether the fluid flowing through the pipe exists only in gas form (single phase) or exists in both gas form and liquid form (multiple phase). A phase behavior model may use the fluid composition in the pipe and the operating characteristics in the pipe to determine the liquid quantity in the pipe. For example, the fluid composition in the pipe and the operating characteristics in the pipe may be used by a phase behavior model to determine the mass fractions of gas and liquid in the pipe. The fluid composition in the pipe and the operating characteristics in the pipe may be used by a phase behavior model to determine the densities of gas and liquid in the pipe. For example, the Gibbs free energy minimization method may be used to calculate the theoretical liquid fraction in the pipe. Gibbs free energy minimization may assume steady-state condition inside the pipe. The densities of gas and liquid may be used to calculate the volume fractions of gas and liquid from the mass fractions of gas and liquid. The fluid composition in the pipe and the operating characteristics in the pipe may be used by a phase behavior model to determine liquid fraction in the pipe.

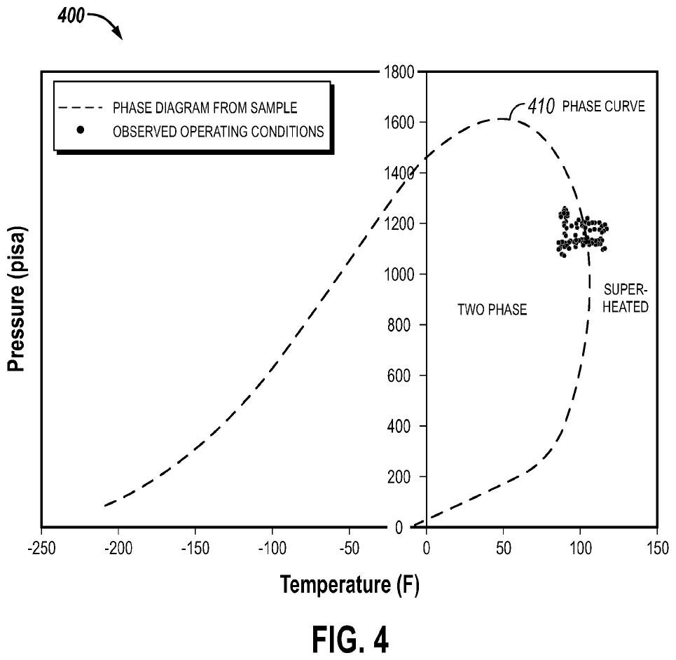

FIG. 4 illustrates an example phase diagram 400. The phase diagram 400 shows the phases of sample fluid having a particular fluid composition. The phase diagram 400 may include a phase curve 410 that separates different forms in which the sample fluid may exist under different pressure and temperature conditions. When the sample fluid is placed in operating conditions that are within the phase curve 410 (two phase), the sample fluid may exist in both gas form and liquid form. When the sample fluid is placed in operating conditions that are outside the phase curve 410, the sample fluid may exist in gas or liquid form.

For example, fluid being transferred through the pipe may include a mixture of propane and methane. For instance, the fluid composition may include 97% methane and 3% propane. Based on the pressure and temperature inside the pipe, the phase behavior model may determine that the methane is in gas form while the propane is in liquid form. That is, the operating characteristics in the pipe may have changed the propane into liquid form as it is being transferred through the pipe.

Theoretical gas flow rate and/or theoretical liquid flow rate may be calculated from the phase behavior model output (e.g., liquid fraction) and the uncorrected gas flow rate. The theoretical gas flow rate may refer to the rate of gas flow that is calculated in the pipe based on the uncorrected gas flow rate and the phase in the pipe determined using one or more models (e.g., phase behavior model, equation of state model). The theoretical liquid flow rate may refer to the rate of liquid flow that is calculated in the pipe based on the uncorrected gas flow rate and the phase in the pipe determined using one or more models.

For example, theoretical gas flow rate may be determined by multiplying the uncorrected gas flow rate by the gas fraction in the pipe. And, theoretical liquid flow rate may be determined by multiplying the uncorrected gas flow rate by the liquid fraction. In some implementations, slip ratio (ratio of gas velocity to liquid velocity) may be used to adjust the theoretical gas flow rate and/or the theoretical liquid flow rate in the pipe. In some implementations, flow regime identification may be used in calculating the theoretical gas flow rate and/or the theoretical liquid flow rate in the pipe. Use of other methods to calculate theoretical gas flow rate and/or theoretical liquid flow rate is contemplated.

The liquid presence component 108 may be configured to determine whether liquid is present in a pipe. Determining whether liquid is present in a pipe may include ascertaining, approximating, calculating, establishing, estimating, finding, identifying, obtaining, quantifying, and/or otherwise determining whether liquid is present in the pipe. Determining whether liquid is present in the pipe may include determining whether wet gas or dry gas is flowing through the pipe. Wet gas may refer to gas carrying liquid (carrying any amount of liquid, carrying at least a threshold amount of liquid). Dry gas may refer to gas not carrying liquid (not carrying any amount of liquid, not carrying more than a threshold amount of liquid). Determining whether liquid is present in the pipe may include determining whether any liquid is present in the pipe. Determining whether liquid is present in the pipe may include determining whether sufficient amount of liquid is present in the pipe to perform gas flow rate correction to account for liquid flowing in the pipe.

Whether liquid is present in the pipe may be determined based on the liquid quantity in the pipe, and/or other information. The liquid quantity in the pipe (determined using the fluid composition in the pipe and the operating characteristics in the pipe) may be used to determine whether the gas that is flowing through the pipe includes/is carrying liquid. The liquid quantity in the pipe may be used to determine whether the gas that is flowing through the pipe includes/is carrying sufficient amount of liquid.

In some implementations, determination of whether liquid is present in the pipe based on the liquid quantity in the pipe may include (1) determination of Lockhart-Martinelli parameter for the fluid in the pipe based on the liquid quantity in the pipe, and (2) determination of whether liquid is present in the pipe based on the Lockhart-Martinelli parameter for the fluid in the pipe. The liquid quantity in the pipe (e.g., liquid fraction) may be converted into the Lockhart-Martinelli parameter. The Lockhart-Martinelli parameter may refer to a dimensionless number used in two-phase flow calculations. The Lockhart-Martinelli parameter may be used to indicate the degree of “wetness” of a wet gas at actual conditions. The value of the Lockhart-Martinelli parameter may express the liquid fraction of a flowing fluid. The value of the Lockhart-Martinelli parameter may indicate how much liquid is present in the gas. The Lockhart-Martinelli parameter (X_{LM}) may be defined as set forth below, where Q is volume flow rate of liquid, Q_{g} is volume flow rate of gas, mi is mass flow rate of liquid, m_{g} is mass flow rate of gas, ρₗ is density of liquid, and ρ_{g} is density of gas:

$${X}_{L M} = \frac{{Q}_{l}}{{Q}_{g}} \sqrt{\frac{{ρ}_{l}}{{ρ}_{g}}} = \frac{{m}_{l}}{{m}_{g}} \sqrt{\frac{{ρ}_{g}}{{ρ}_{l}}}$$

In some implementations, whether liquid is present in the pipe may be determined based on the comparison of the liquid quantity in the pipe, the liquid fraction in the pipe, and/or the Lockhart-Martinelli parameter for the fluid in the pipe to one or more thresholds. Comparison of the liquid quantity/liquid fraction/Lockhart-Martinelli parameter to a threshold may enable control of how high the liquid quantity/liquid fraction/Lockhart-Martinelli parameter can rise in the pipe before the liquid presence is determined. The value of the threshold may control how high the liquid quantity/liquid fraction/Lockhart-Martinelli parameter can rise in the pipe before the amount of liquid is determined to be sufficient that gas flow rate correction should be performed. For example, small values of liquid quantity/liquid fraction/Lockhart-Martinelli parameter may be ignored and uncorrected gas flow rate in the pipe may be used to track flow of gas through the pipe, while large values of liquid quantity/liquid fraction/Lockhart-Martinelli parameter may require correction of the uncorrected gas flow rate to accurately track flow of gas through the pipe.

In reference to FIG. 1, the correction component 110 may be configured to, responsive to the determination that liquid is present in the pipe, determine a liquid-corrected gas flow rate in the pipe. Determining the liquid-corrected gas flow rate in the pipe may include ascertaining, approximating, calculating, establishing, estimating, finding, identifying, obtaining, quantifying, selecting, setting, and/or otherwise determining the liquid-corrected gas flow rate in the pipe. A liquid-corrected gas flow rate in the pipe may refer to a gas flow rate that has been corrected to account for the presence of liquid in the pipe. A liquid-corrected gas flow rate in the pipe may refer to a gas flow rate that has been adjusted from the measured (uncorrected) gas flow rate to account for the error in gas flow rate measurement due to the presence of liquid in the pipe. A gas flow rate in the pipe may refer to a rate at which gas is flowing through the pipe (e.g., by mass, by volume).

The liquid-corrected gas flow rate in the pipe may be determined based on the fluid composition in the pipe, the operating characteristics in the pipe, the liquid quantity (e.g., the liquid fraction, Lockhart-Martinelli parameter) in the pipe, and/or other information. The liquid-corrected gas flow rate may be determined by (1) measuring the uncorrected gas flow rate in the pipe and (2) determining an over-read or an under-read of the gas flow rate in the pipe. The over-read and under-read may quantify the extent to which the measured (uncorrected) gas flow rate deviates from the actual gas flow rate in the pipe.

For example, the uncorrected gas flow rate in the pipe may be determined based on the fluid composition in the pipe, the operating characteristics in the pipe, and/or other information. Rather than directly measuring the uncorrected gas flow rate, the fluid composition in the pipe and the operating characteristics may be measured to calculate (indirectly measure) the uncorrected gas flow rate in the pipe. Measurement may include real-time measurement, historical measurement, periodic measurement, and/or other measurement.

The over-read or the under-read of the gas flow rate in the pipe may be determined based on the liquid quantity in the pipe and/or other information. For example, the liquid fraction in the pipe may be used to calculate the over-read or the under-read of the measured (uncorrected) gas flow rate in the pipe. In some implementations, the calculation of the over-read or the under-read of the uncorrected gas flow rate in the pipe may be performed using one or more correction equations, such as provided in the correction method set forth in ISO TR 11583 and/or ISO TR 12748.

For example, over-read/under-read of the uncorrected gas flow rate in the pipe may be determined via one or more methods that utilizes the Lockhart-Martinelli parameter. For instance, ISO TR 12748 provides the following method to calculate the over-read (OR) of the uncorrected gas flow rate in the pipe using the Lockhart-Martinelli parameter.

$$OR = \sqrt{1 + C \cdot {X}_{L M} + {X}_{L M}^{2}} , where C = {( \frac{{ρ}_{g}}{{ρ}_{l}} )}^{n} + {( \frac{{ρ}_{l}}{{ρ}_{g}} )}^{n}$$

$$gas Froude number , \\ {Fr}_{g} = \sqrt{\frac{Superficial Gas Inertia Force}{Liquid Gravity Force}} = \frac{V {s}_{g}}{\sqrt{g \cdot D}} \cdot \sqrt{\frac{{ρ}_{g}}{{ρ}_{l} - {ρ}_{g}}} ,$$

where Vs_{g} is superficial gas velocity, g is acceleration due to gravity, and D is meter inlet pipe diameter
   water to liquid mass ratio,

$$W L M R = \frac{{\dot{m}}_{w}}{{\dot{m}}_{l}} ,$$

where \dot{m}_{w} is mass of water and mi is mass of liquid

$$A = 0.4 - 0.1 * exp ( - WLMR )$$

$$F {r}_{g , t r a n s i t i o n} = 1.5 + 0.2 * WLMR$$

$$if {Fr}_{g} < F {r}_{g , t r a n s i t i o n} \to n = ( \frac{1}{\sqrt{2}} - \frac{A}{\sqrt{F {r}_{g , transition}}} ) \hat{} 2$$

$$if {Fr}_{g} > F {r}_{g , t r a n s i t i o n} \to n = ( \frac{1}{\sqrt{2}} - \frac{A}{\sqrt{F {r}_{g}}} ) \hat{} 2$$

Other determination of the over-read and/or the under-read of the uncorrected gas flow rate in the pipe is contemplated.

The liquid-corrected gas flow rate in the pipe may be determined based on the uncorrected gas flow rate in the pipe, the over-read or the under-read of the uncorrected gas flow rate in the pipe, and/or other information. Once the over-read/under-read of the uncorrected gas flow rate in the pipe has been determined, the over-read/under-read may be used to correct the uncorrected gas flow rate in the pipe. For example, the liquid-corrected gas flow rate in the pipe may be computed by dividing the uncorrected gas flow rate in the pipe with the over-read/under-read value. Other determination of the liquid-corrected gas flow rate in the pipe is contemplated.

For example, the uncorrected mass flow rate of gas (m_{g uncorrected}) measured in the pipe may be corrected for the overread to calculate the liquid-corrected mass flow rate of gas (m_{g}) as set forth below. The volume flow rate of gas may be measured and corrected using the overread. The underread may be used to correct the mass flow rate and/or volume flow rate of gas in the pipe in the same/similar way. Other correction of the gas flow rate in the pipe is contemplated.

$${m}_{g} = \frac{{m}_{g uncorrected}}{OR}$$

In some implementations, total transferred gas over a time period may be determined based on the liquid-corrected gas flow rate and/or other information. Total transferred gas over a time period may refer to the total amount of gas that is transferred over the time period using the pipe. The liquid-corrected gas flow rate may be used to determine the total amount of gas that is transferred over the time period in which liquid is present in the pipe. When the gas in the pipe is determined to be carrying liquid, the liquid-corrected gas flow rate, rather than the measured (uncorrected) gas flow rate, may be used to determine the amount of gas transfer. The liquid-corrected gas flow rate may be multiplied by the time period to accurately determine how much gas has been transferred over the time period using the pipe. Such determination of the total transferred gas over the time period may enable more accurate tracking of gas transfer (e.g., for billing purposes) and/or more accurate control/allocation of gas transfer.

In some implementations, total transferred gas over a time period may be determined based on the measured (uncorrected) gas flow rate and/or other information. The measured (uncorrected) gas flow rate may be used to determine the total amount of gas that is transferred over the time period in which liquid is not present in the pipe. When the gas in the pipe is determined to not be carrying liquid, the measured (uncorrected) gas flow rate may be used to determine the amount of gas transfer. The measured (uncorrected) gas flow rate may be multiplied by the time period to determine how much gas has been transferred over the time period using the pipe.

In some implementations, the determination of the liquid quantity in the pipe may further include determination of a liquid flow rate in the pipe. A liquid flow rate in the pipe may refer to a rate at which liquid is flowing through the pipe (e.g., by mass, by volume). The liquid flow rate in the pipe may be determined based on the liquid quantity/liquid fraction in the pipe and/or other information. In some implementations, the liquid quantity/liquid fraction in the pipe may be used to determine a Lockhart-Martinelli parameter for the pipe, and the Lockhart-Martinelli parameter may be used to correct the overread/underread of the gas flow rate in the pipe. The Lockhart-Martinelli parameter and the liquid-corrected gas flow rate may be used to determine the liquid flow rate in the pipe. For example, the mass flow rate of liquid (mₗ) in the pipe may be calculated using the liquid-corrected gas flow rate (m_{g}), the value of the Lockhart-Martinelli parameter, and the density ratio of liquid and gas (ρₗ/ρ_{g}) as set forth below. Other determination of the liquid flow rate in the pipe is contemplated.

$${m}_{l} = {X}_{L M} {m}_{g} \sqrt{\frac{{ρ}_{l}}{{ρ}_{g}}}$$

In some implementations, total transferred liquid over a time period may be determined based on the liquid flow rate and/or other information. Total transferred liquid over a time period may refer to the total amount of liquid that is transferred over the time period using the pipe. The liquid flow rate may be multiplied by the time period to accurately determine how much liquid has been transferred over the time period using the pipe. Such determination of the total transferred liquid over the time period may enable more accurate tracking of liquid transfer (e.g., for billing purposes) and/or more accurate control/allocation of liquid transfer.

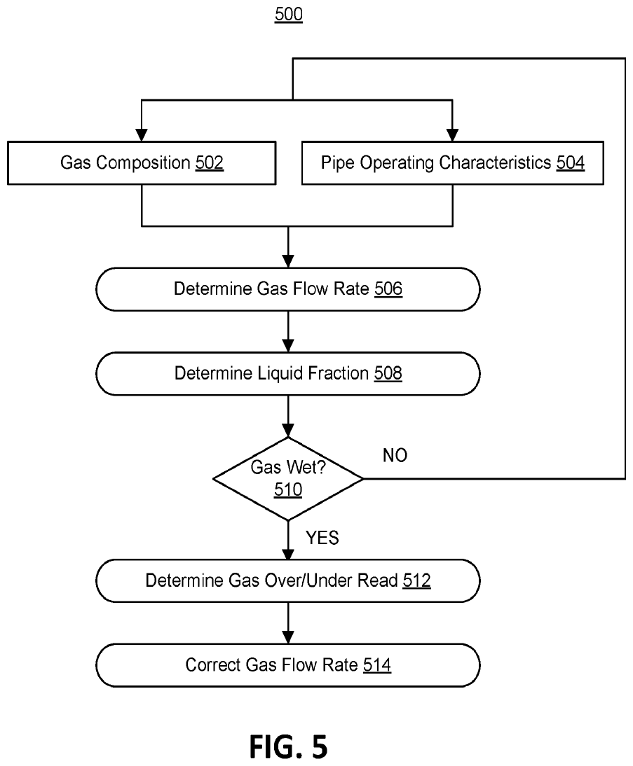

FIG. 5 illustrates an example flow diagram 500 for correcting gas flow rate in a pipe. At step 502, fluid composition in a pipe may be obtained. At step 504, pipe operating characteristics (e.g., temperature, pressure, differential pressure) may be obtained. At step 506, uncorrected gas flow rate in the pipe may be obtained. Obtaining the uncorrected gas flow rate may include measuring the uncorrected gas flow rate, retrieving previously measured uncorrected gas flow rate, calculating the uncorrected gas flow rate (e.g., using temperature, pressure, and differential pressure, and fluid composition in the pipe), and/or otherwise obtaining the uncorrected gas flow rate.

At step 508, liquid fraction in the pipe may be determined. The liquid fraction in the pipe may be determined using one or more models (phase behavior model, equation of state model). The model(s) may estimate the liquid fraction in the pipe for one or more types of fluid in the pipe. The model(s) may use the operating characteristics of the pipe to determine whether the fluid is in gas form, liquid form, and/or gas and liquid form. In some implementations, step 508 may further include determination of the Lockhart-Martinelli parameter for the fluid in the pipe. The Lockhart-Martinelli parameter for the fluid in the pipe may be determined using theoretical liquid flow rate, theoretical gas flow rate, theoretical liquid density, and theoretical gas density in the pipe.

Theoretical liquid fraction, theoretical gas fraction, theoretical liquid density, and theoretical gas density in the pipe may be calculated for the fluid composition in the pipe at flowing temperature and pressure by using equation of state and/or phase behavior model. Gibbs free energy minimization method may be used. By conservation of mass, the theoretical gas fraction may be calculated as the difference between one and the theoretical liquid fraction. The theoretical densities of gas and liquid may be used to calculate the theoretical volume fractions of gas and liquid from the theoretical mass fractions of gas and liquid, or vice versa.

The theoretical liquid flow rate in the pipe may be calculated as the product of the uncorrected gas flow rate in the pipe and the theoretical liquid fraction in the pipe. The theoretical gas flow rate in the pipe may be calculated as the product of the uncorrected gas flow rate in the pipe and the theoretical gas fraction in the pipe. Calculation of the theoretical liquid flow rate and the theoretical gas flow rate in the pipe may include use of slip ratio and/or use of flow regime identification. The theoretical liquid flow rate, the theoretical gas flow rate, the theoretical liquid density, and the theoretical gas density may be used to calculate the Lockhart-Martinelli parameter for the fluid in the pipe.

At step 510, whether gas in the pipe is carrying liquid (the pipe is carrying wet gas) may be determined based on the liquid fraction determined in step 508. In some implementations, whether gas in the pipe is carrying liquid may be determined using the Lockhart Martinelli parameter. If the gas in the pipe is determined to not be carrying liquid (e.g., not carrying any liquid, not carrying a sufficient amount of liquid), such as based on the liquid fraction being below a threshold value (e.g., Lockhart Martinelli parameter being below a threshold value), the process returns to steps 502 and 504 to perform the analysis for another time (next time step). If the gas in the pipe is determined to be carrying liquid, such as based on the liquid fraction being above the threshold value, the over read or the under read of the gas flow rate is determined based on the liquid fraction (e.g., Lockhart Martinelli parameter) at step 512, such as by using the ISO TR 11583 and/or the ISO TR 12748. At step 514, the uncorrected gas flow rate is corrected using the over read/under read to calculate the liquid-corrected gas flow rate. The liquid-corrected gas flow rate may be used to determine the liquid flow rate in the pipe.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). A machine-readable medium may include non-transitory computer-readable medium. For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In reference to FIG. 1, in some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11. The system 10 may be implemented in a single computing device, across multiple computing devices, in a client-server environment, in a cloud environment, and/or in other devices/configuration of devices. The system 10 may be implemented using a computer, a desktop, a laptop, a phone, a tablet, a mobile device, a server, and/or other computing devices.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

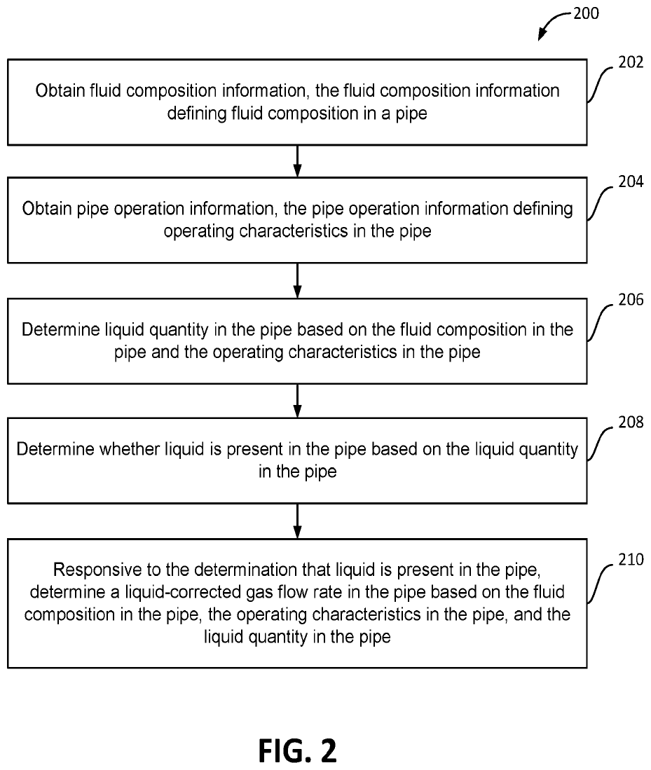

FIG. 2 illustrates method 200 for quantifying liquid and correcting gas flow rate in gas pipeline. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, fluid composition information may be obtained. The fluid composition information may define fluid composition in a pipe. In some implementations, operation 202 may be performed by a processor component the same as or similar to the fluid composition component 102 (Shown in FIG. 1 and described herein).

At operation 204, pipe operation information may be obtained. The pipe operation information may define operating characteristics in the pipe. In some implementations, operation 204 may be performed by a processor component the same as or similar to the pipe operation component 104 (Shown in FIG. 1 and described herein).

At operation 206, liquid quantity in the pipe may be determined based on the fluid composition in the pipe, the operating characteristics in the pipe, and/or other information. In some implementations, operation 206 may be performed by a processor component the same as or similar to the liquid quantity component 106 (Shown in FIG. 1 and described herein).

At operation 208, whether liquid is present in the pipe may be determined based on the liquid quantity in the pipe and/or other information. In some implementations, operation 208 may be performed using a processor component the same as or similar to the liquid presence component 108 (Shown in FIG. 1 and described herein).

At operation 210, responsive to the determination that liquid is present in the pipe, a liquid-corrected gas flow rate in the pipe may be determined based on the fluid composition in the pipe, the operating characteristics in the pipe, the liquid quantity in the pipe, and/or other information. In some implementations, operation 210 may be performed using a processor component the same as or similar to the correction component 110 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

1. A system for quantifying liquid and correcting gas flow rate in a gas pipeline, the system comprising:
one or more physical processors configured by machine-readable instructions to:
obtain fluid composition information, the fluid composition information defining fluid composition in a pipe;
obtain pipe operation information, the pipe operation information defining operating characteristics in the pipe;
determine liquid quantity in the pipe based on the fluid composition in the pipe and the operating characteristics in the pipe;
determine whether liquid is present in the pipe based on the liquid quantity in the pipe; and
responsive to the determination that liquid is present in the pipe, determine a liquid-corrected gas flow rate in the pipe based on the fluid composition in the pipe, the operating characteristics in the pipe, and the liquid quantity in the pipe.

2. The system of claim 1, wherein the fluid composition in the pipe includes a breakdown of fluid components in the pipe by number and/or mass.

3. The system of claim 2, wherein the operating characteristics in the pipe include temperature, differential pressure, static pressure, and uncorrected gas flow rate in the pipe.

4. The system of claim 3, wherein a flow restriction is located along the pipe and the differential pressure is measured between a first point along the pipe and a second point along the pipe, the first point being on a first side of the flow restriction and the second point being on a second side of the flow restriction, and the static pressure is measured on the first side or the second side of the flow restriction.

5. The system of claim 3, wherein the determination of the liquid quantity in the pipe based on the fluid composition in the pipe and the operating characteristics in the pipe includes determination of phase in the pipe based on the breakdown of the fluid components in the pipe by number and/or mass, the temperature, and the static pressure.

6. The system of claim 1, wherein the determination of the liquid quantity in the pipe includes determination of a liquid fraction in the pipe.

7. The system of claim 6, wherein the determination of the liquid quantity in the pipe further includes determination of a liquid flow rate in the pipe.

8. The system of claim 7, wherein total transferred liquid over a time period is determined based on the liquid flow rate.

9. The system of claim 1, wherein the determination of the liquid-corrected gas flow rate in the pipe based on the fluid composition in the pipe, the operating characteristics in the pipe, and the liquid quantity in the pipe includes:
determination of an uncorrected gas flow rate in the pipe based on the fluid composition in the pipe and the operating characteristics in the pipe or based on gas flow rate measurement;
determination of an over-read or an under-read of the uncorrected gas flow rate in the pipe based on the liquid quantity in the pipe; and
determination of the liquid-corrected gas flow rate in the pipe based on the uncorrected gas flow rate in the pipe and the over-read or the under-read of the gas flow rate in the pipe.

10. The system of claim 1, wherein total transferred gas over a time period is determined based on the liquid-corrected gas flow rate.

11. A method for quantifying liquid and correcting gas flow rate in a gas pipeline, the method comprising:
obtaining fluid composition information, the fluid composition information defining fluid composition in a pipe;
obtaining pipe operation information, the pipe operation information defining operating characteristics in the pipe;
determining liquid quantity in the pipe based on the fluid composition in the pipe and the operating characteristics in the pipe;
determining whether liquid is present in the pipe based on the liquid quantity in the pipe; and
responsive to the determination that liquid is present in the pipe, determining a liquid-corrected gas flow rate in the pipe based on the fluid composition in the pipe, the operating characteristics in the pipe, and the liquid quantity in the pipe.

12. The method of claim 11, wherein the fluid composition in the pipe includes a breakdown of fluid components in the pipe by number and/or mass.

13. The method of claim 12, wherein the operating characteristics in the pipe include temperature, differential pressure, static pressure, and uncorrected gas flow rate in the pipe.

14. The method of claim 13, wherein a flow restriction is located along the pipe and the differential pressure is measured between a first point along the pipe and a second point along the pipe, the first point being on a first side of the flow restriction and the second point being on a second side of the flow restriction, and the static pressure is measured on the first side or the second side of the flow restriction.

15. The method of claim 13, wherein determining the liquid quantity in the pipe based on the fluid composition in the pipe and the operating characteristics in the pipe includes determining phase in the pipe based on the breakdown of the fluid components in the pipe by number and/or mass, the temperature, and the static pressure.

16. The method of claim 11, wherein determining the liquid quantity in the pipe includes determining a liquid fraction in the pipe.

17. The method of claim 16, wherein determining the liquid quantity in the pipe further includes determining a liquid flow rate in the pipe.

18. The method of claim 17, wherein total transferred liquid over a time period is determined based on the liquid flow rate.

19. The method of claim 11, wherein determining the liquid-corrected gas flow rate in the pipe based on the fluid composition in the pipe, the operating characteristics in the pipe, and the liquid quantity in the pipe includes:
determining an uncorrected gas flow rate in the pipe based on the fluid composition in the pipe and the operating characteristics in the pipe or based on gas flow rate measurement;
determining an over-read or an under-read of the uncorrected gas flow rate in the pipe based on the liquid quantity in the pipe; and
determining the liquid-corrected gas flow rate in the pipe based on the uncorrected gas flow rate in the pipe and the over-read or the under-read of the gas flow rate in the pipe.

20. The method of claim 11, wherein total transferred gas over a time period is determined based on the liquid-corrected gas flow rate.
